(19) United States
(12) Patent Application Publication
(10) Pub. No.: US 2021/0208567 A1
(43) Pub. Date: Jul. 8, 2021

(54) METHODS AND SYSTEMS FOR USING THREE-DIMENSIONAL (3D) MODEL CUTS BASED ON ANATOMY FOR THREE-DIMENSIONAL (3D) PRINTING

(71) Applicant: GE Precision Healthcare LLC, Milwaukee, WI (US)

(72) Inventors: Jerome Knoplioch, Neuilly Sur Seine (FR); Celine Pruvot, Buc (FR); Jerome Durant, Paris (FR); Adeline Digard, Bonnelles (FR); Ilan Stefanon, Massy (FR); Amaury Walbron, Massy (FR); Riadh Ben Salah, Porcheville (FR)

(21) Appl. No.: 16/736,117

(22) Filed: Jan. 7, 2020

(51) Int. Cl. G05B 19/4099; G06T 19/20; G06T 7/62; B29C 64/393; B33Y 80/00

(52) U.S. Cl. CPC G05B 19/4099; G06T 19/20; G06T 7/62; B29C 64/393; G06T 2219/2021; G05B 2219/49019; G06T 2210/41; G06T 2219/2008; B33Y 80/00

(57) ABSTRACT

Systems and methods are provided for three-dimensional (3D) printing with three-dimensional (3D) model cuts based on anatomy, in particular during medical imaging operations.

### FIELD

Aspects of the present disclosure relate to medical imaging solutions. More specifically, certain embodiments in accordance with the present disclosure relate to methods and systems for using three-dimensional (3D) model cuts based on anatomy for three-dimensional (3D) printing.

### BACKGROUND

Various medical imaging techniques may be used to image organs and soft tissues in a human body, such as ultrasound imaging, computed tomography (CT) scans, magnetic resonance imaging (MRI), and the like. The manner by which images are generated during medical imaging depends on the particular technique.

For example, in ultrasound imaging real time, non-invasive high frequency sound waves are used to produce ultrasound images, typically of organs, tissues, objects, etc. inside the human body. Images produced or generated during medical imaging may be two-dimensional (2D), three-dimensional (3D), and/or four-dimensional (4D) images (essentially real-time/continuous 3D images). Typically, during medical imaging, imaging datasets (volumetric imaging datasets during 3D/4D imaging) are acquired and used in generating and rendering the corresponding images (e.g., via a display) in real-time.

In some instances, it may be desirable to generate three-dimensional (3D) objects corresponding to the structures depicted in the medical images, which is commonly referred to as 3D printing. Three-dimensional (3D) printing of physical models may provide anatomical structures useful for surgical planning, research, medical product development, keepsakes, and the like. Three-dimensional (3D) printing may have certain challenges and limitations, however. In this regard, existing processes for 3D printing physical models from medical imaging datasets may typically be complex, time-consuming, and challenging.

Further limitations and disadvantages of conventional and traditional approaches will become apparent to one of skill in the art, through comparison of such systems with some aspects of the present disclosure, as set forth in the remainder of the present application with reference to the drawings.

### BRIEF SUMMARY

System and methods are provided for three-dimensional (3D) model cuts based on anatomy for three-dimensional (3D) printing, substantially as shown in and/or described in connection with at least one of the figures, as set forth more completely in the claims.

These and other advantages, aspects and novel features of the present disclosure, as well as details of one or more illustrated example embodiments thereof, will be more fully understood from the following description and drawings.

### BRIEF DESCRIPTION OF THE DRAWINGS

FIG. 1A is a block diagram illustrating an example medical imaging arrangement that supports three-dimensional (3D) printing.

FIG. 1B is a block diagram illustrating an example medical imaging arrangement that supports three-dimensional (3D) printing, with offloaded 3D print data processing.

FIG. 2 is a block diagram illustrating an example ultrasound system that may be configured for supporting three-dimensional (3D) visualization and/or printing with three-dimensional (3D) model cuts based on anatomy.

FIGS. 3A-3B illustrate an example workflow for manually controlled process for generating three-dimensional (3D) visualization and/or printing with three-dimensional (3D) model cuts based on anatomy during medical imaging.

FIGS. 4A-4B illustrate an example workflow for manually controlled process for generating three-dimensional (3D) model cuts, using multiple cut planes, based on anatomy for three-dimensional (3D) visualization and/or printing during medical imaging.

FIGS. 5A-5B illustrate an example workflow for automatically controlled process for generating three-dimensional (3D) model cuts, based on anatomy for three-dimensional (3D) visualization and/or printing during medical imaging.

FIG. 6 illustrates a three-dimensional (3D) model pulmonary cut generated using advanced workflow for generating three-dimensional (3D) model cuts, based on anatomy for three-dimensional (3D) visualization and/or printing during medical imaging.

FIG. 7 illustrates a flowchart of an example steps that may be performed for three-dimensional (3D) visualization and/or printing with three-dimensional (3D) model cuts based on anatomy.

### DETAILED DESCRIPTION

Certain implementations in accordance with the present disclosure may be directed to three-dimensional (3D) visualization and/or printing with three-dimensional (3D) model cuts based on anatomy. In particular, various embodiments have the technical effect of enhancing printing of physical objects, particularly in conjunction with medical imaging, by accounting for and including the 3D model prints internal spaces and/or structures. This may be done, for example, by generating volume rendering from volumetric imaging data; displaying the volume rendering; and based on one or more cut surfaces corresponding to object(s) in the volume rendering, generating three-dimensional (3D) visualization and/or printing data that includes data corresponding to or representing internal objects and/or internal spaces within the object.

The foregoing summary, as well as the following detailed description of certain embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors or memories) may be implemented in a single piece of hardware (e.g., a general purpose signal processor or a block of random access memory, hard disk, or the like) or multiple pieces of hardware. Similarly, the programs may be stand-alone programs, may be incorporated as subroutines in an operating system, may be functions in an installed software package, and the like. It should be understood that the various embodiments are not limited to the arrangements and instrumentality shown in the drawings. It should also be understood that the embodiments may be combined, or that other embodiments may be utilized and that structural, logical and electrical changes may be made without departing from the scope of the various embodiments. The following detailed description is, therefore, not to be taken in a limiting sense, and the scope of the present disclosure is defined by the appended claims and their equivalents.

As used herein, an element or step recited in the singular and preceded with the word “a” or “an” should be understood as not excluding plural of said elements or steps, unless such exclusion is explicitly stated. Furthermore, references to “an exemplary embodiment,” “various embodiments,” “certain embodiments,” “a representative embodiment,” and the like are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional elements not having that property.

Also as used herein, the term “image” broadly refers to both viewable images and data representing a viewable image. However, many embodiments generate (or are configured to generate) at least one viewable image. In addition, as used herein, the phrase “image” is used to refer to an ultrasound mode such as B-mode (2D mode), M-mode, three-dimensional (3D) mode, CF-mode, PW Doppler, CW Doppler, MGD, and/or sub-modes of B-mode and/or CF such as Shear Wave Elasticity Imaging (SWEI), TVI, Angio, B-flow, BMI, BMI_Angio, and in some cases also MM, CM, TVD where the “image” and/or “plane” includes a single beam or multiple beams.

In addition, as used herein, the phrase “pixel” also includes embodiments where the data is represented by a “voxel.” Thus, both the terms “pixel” and “voxel” may be used interchangeably throughout this document.

Furthermore, the term processor or processing unit, as used herein, refers to any type of processing unit that can carry out the required calculations needed for the various embodiments, such as single or multi-core: CPU, Accelerated Processing Unit (APU), Graphics Board, DSP, FPGA, ASIC, or a combination thereof. In various embodiments, imaging processing, including visualization enhancement, to form images may be performed, for example, in software, firmware, hardware, or a combination thereof.

It should be noted that various embodiments described herein that generate or form images may include processing for forming images that in some embodiments includes beamforming and in other embodiments does not include beamforming. For example, an image can be formed without beamforming, such as by multiplying the matrix of demodulated data by a matrix of coefficients so that the product is the image, and wherein the process does not form any “beams”. In addition, forming of images may be performed using channel combinations that may originate from more than one transmit event (e.g., synthetic aperture techniques).

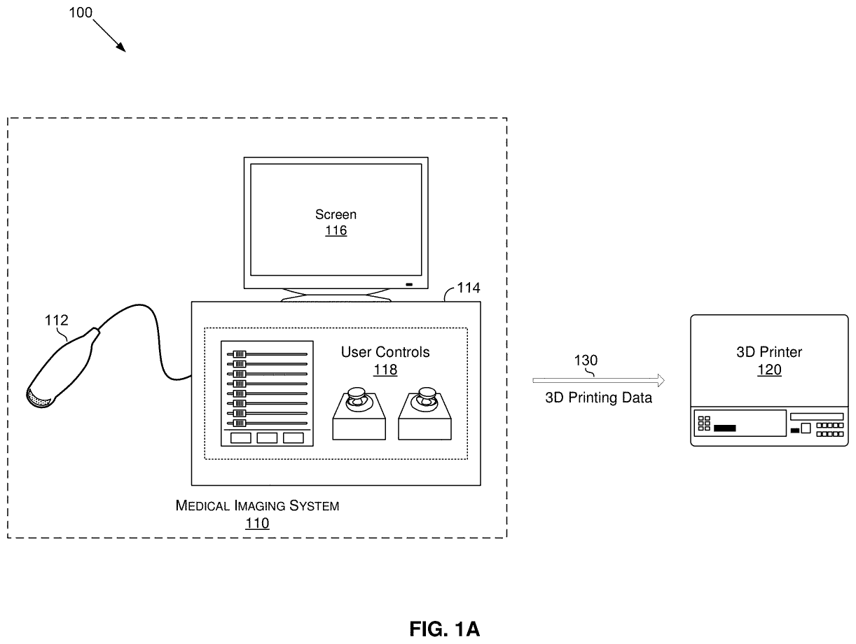

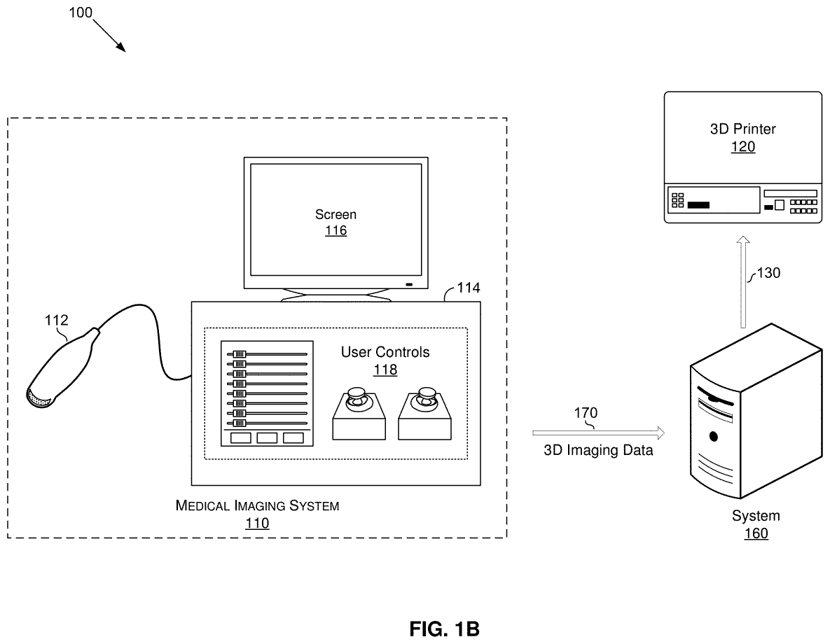

FIG. 1A is a block diagram illustrating an example medical imaging arrangement that supports three-dimensional (3D) printing. Shown in FIG. 1A is a medical imaging arrangement 100 comprising a medical imaging system 110 and a three-dimensional (3D) printer 120.

The medical imaging system 110 may comprise suitable logic, circuitry, interfaces and/or code that may be operable to acquire medical image data, process the medical image data to provide a volume rendering, and process the volume rendering, such as to provide 3D models suitable for 3D visualization and/or printing of objects in the volume rendering. In various embodiments, the medical imaging system 110 may be an ultrasound system, MRI imaging system, CT imaging system, or any suitable imaging system operable to generate and render medical image data. The medical imaging system 110 may comprise a scanner 112, a display/control unit 114, a display screen 116, and user controls 118. The scanner 112 may be an ultrasound probe, MRI scanner, CT scanner, or any suitable imaging device. The imaging device may comprise suitable logic, circuitry, interfaces and/or code that may be operable to capture and/or generate a particular type of imaging signals (or data corresponding thereto), such as by being moved over a patient's body (or part thereof).

The display/control unit 114 may comprise suitable logic, circuitry, interfaces and/or code that may be operable to process image data and display images (e.g., via the display screen 116). For example, the display/control unit 114 may comprise suitable logic, circuitry, interfaces and/or code that may be operable to acquire volumetric image data and perform volume rendering on 3D and/or 4D volumes. The display/control unit 114 may generate and present volume renderings (e.g., 2D projections) of the volumetric (e.g., 3D and/or 4D) datasets. In this regard, rendering a 2D projection of a 3D and/or 4D dataset may comprise setting or defining a perception angle in space relative to the object(s) being displayed, and then defining or computing necessary information (e.g., opacity and color) for every voxel in the dataset. This may be done, for example, using suitable transfer functions for defining RGBA (red, green, blue, and alpha) value for every voxel. The resulting volume rendering may include a depth map correlating a depth value to each pixel in the 2D projection. The display/control unit 114 may be operable to present the generated volume rendering at the display screen 116 and/or store the generated volume rendering at any suitable data storage medium.

The display/control unit 114 may support user interactions (e.g., via user controls 118), such as to allow controlling of the medical imaging. The user interactions may comprise user input or commands controlling display of images, selecting settings, specifying user preferences, providing feedback as to quality of imaging, etc. In some embodiments, the display/control unit 114 may support user interactions relating to 3D modeling of volume renderings. For example, the display/control unit 114 may comprise suitable logic, circuitry, interfaces and/or code that may be operable to generate 3D model(s) (e.g., a multi-colored 3D polygonal model) based on a volume rendering in response to a user selection via user controls 118.

As an example, a user viewing a volume rendering at the display screen 116 may desire to print 3D model(s) of the anatomical object(s) depicted in the volume rendering. Accordingly, the user may select 3D model(s) and color generation option to receive the multi-colored 3D polygonal model that may be provided to 3D printing software of the 3D printer 120 to print the 3D model(s) of the object(s) in multiple colors. The multi-colored 3D polygonal model may appear substantially as shown in the volume rendering, thereby providing the user with a “what you see is what you get” one-click workflow from volume rendering to multi-colored 3D polygonal model.

The user controls 118 may be utilized to input patient data, imaging parameters, settings, select protocols and/or templates, select an examination type, select acquisition and/or display processing parameters, initiate volume rendering, initiate multi-colored 3D mesh generation, and the like. In an exemplary embodiment, the user controls 118 may be operable to configure, manage and/or control operation of one or more components and/or modules in the medical imaging system 110. The user controls 118 may include button(s), rotary encoder(s), a touchscreen, motion tracking, voice recognition, a mouse device, keyboard, camera and/or any other device capable of receiving a user directive. In certain embodiments, one or more of the user controls 118 may be integrated into other components, such as the display screen 116, for example. As an example, user controls 118 may include a touchscreen display.

The display screen 116 may be any device capable of communicating visual information to a user. For example, the display screen 116 may include a liquid crystal display, a light emitting diode display, and/or any suitable display or displays. The display screen 116 can be operable to present medical images and/or any suitable information. For example, the medical images presented at the display screen may include ultrasound images, CT images, MRI images, volume renderings, multi-colored 3D meshes (also referred to as multi-colored 3D polygonal models), and/or any suitable information.

The 3D printer 120 may comprise suitable logic, circuitry, interfaces and/or code that may be operable to perform 3D printing. In this regard, the 3D printer 120 may be configured to produce (e.g., synthesize) three-dimensional physical representations, such as based on 3D printing data corresponding to and/or based on multi-colored 3D polygonal models of the would-be printed objects. The 3D printer 120 may be any of commercially available products, which may be communicatively coupled to the medical imaging system 110, via suitable connections, wired (e.g., cords) and/or wireless (e.g., WiFi, Bluetooth, etc.). The 3D printer 120 may also be part of the medical imaging system 110 itself, and may even by incorporated directly into it.

In operation, the medical imaging system 110 may be used in generating and presenting volume renderings. The volume renderings may be used to generate multi-color 3D polygonal models suitable for 3D printing. The medical imaging system 110 may be operable to support 3D printing, for example, via the 3D printer 120. The 3D printer 120 may be operable to generate physical volume representations of objects and/or structures in the volume renderings. For example, expecting parent(s) may want to have 3D prints of ultrasound images displayed during obstetric (OB) imaging scans as a keepsake, such as a fetus and/or particular features thereof (e.g., face). The 3D prints or data corresponding thereto may also be useful as reference for medical services, such as to help generate a model for use in surgical planning.

The 3D physical objects may be synthesized using the 3D printer 120. The 3D printer 120 may be operable to use additive processes to lay successive layers of material. The synthesized volume objects may be of almost any shape and/or geometry. The 3D printer 120 and/or 3D printing operations may be configured and/or controlled based on 3D printing data 130, which may comprise information corresponding to and/or representing the would-be printed objects (or structures thereof). The 3D printing data 130 may be generated based on the multi-color 3D polygonal models and may be formatted in accordance with one or more defined formats for use in 3D printing, such as stereolithography (STL) file format based data. In this regard, the 3D printing data 130 may be generated and/or configured based on 3D modeling of the objects and/or structures in the volume renderings, and may be formatted based on the supported printing data formats in the 3D printer 120.

As illustrated in FIG. 1A, the generation of the 3D printing data 130 is shown as being done directly in the medical imaging system 110 (e.g., within the display/control unit 114, using suitable processing circuitry therein). The disclosure is not so limited, however, and as such in some implementations at least some of the processing performed to generate the 3D printing data based on the imaging related information may be offloaded, such as to a different/dedicated system, which may be located near or remote from the imaging setup, and which may be configured for generating 3D printing data based on imaging related data received from the medical imaging system. An example of such arrangement is shown and described with respect to FIG. 1B.

FIG. 1B is a block diagram illustrating an example medical imaging arrangement that supports three-dimensional (3D) printing, with offloaded 3D print data processing. Referring to FIG. 1B, the medical imaging arrangement 150 may comprise the medical imaging system 110 and the 3D printer 120 as well as a computing system 160.

The computing system 160 may comprise suitable logic, circuitry, interfaces and/or code that may be operable to process, store, and/or communicate data. The computing system 160 may be configured for generating 3D printing data, such as based on 3D imaging data received from medical imaging systems. For example, the computing system 160 may be operable to receive from the medical imaging system 110, 3D imaging data 170, comprising, for example, volumetric medical imaging datasets and/or volume renderings corresponding to the volumetric medical imaging datasets. The computing system 160 may be operable to generate multi-color 3D surface meshes from the volume renderings. The computing system 160 may be operable to format the multi-color 3D surface meshes to generate 3D printing data 130 that may be transmitted to a 3D printer 120.

The computing system 160 may be dedicated equipment configured particularly for use in conjunction with medical imaging, including in support of 3D printing; or it may be a general purpose computing system (e.g., personal computer, server, etc.) setup and/or configured to perform the operations described with respect to the computing system 160. Communications between the different elements in the medical imaging arrangement 150 may be done using available wired and/or wireless connections, and/or in accordance any suitable communication (and/or networking) standards or protocols.

In an example implementation, the 3D printing data 130 may be generated via the medical imaging system 110 or the computing system 160 based on multi-color 3D surface mesh representations, which may be generated based on the volume rendering of the volumetric datasets acquired via the medical imaging system 110. Providing 3D printing in this manner ensures that 3D prints look substantially the same as the rendering on the display screen 116. Also, a fully automated workflow from volume data to 3D printing is possible with this approach, allowing for efficient and/or easy-to-use operation. Further, the rendering operations may enhance the quality of the 3D printing. For example, the rendering algorithm may act as non-linear filter smoothing the data and producing very reliable depth information compared to other segmentation methods. The rendered image may also be used in texturing the 3D prints to enhance quality of printed objects. This approach may also allow for control of the 3D printing by the user, such as based on user input (provided via the user controls 118). For example, the 3D printing may be controlled by the user based on user input relating to the volume rendering (e.g., selection of viewpoint, scaling, threshold, etc.). Further, the 3D printing may reflect use of techniques available for volume rendering, such as to cut away unwanted parts of the volume (e.g., masking with MagiCut, Vocal, Threshold, etc.). In other words, the 3D prints may only include the wanted parts of the objects.

In accordance with present disclosure, arrangements comprising medical imaging systems (e.g., the medical imaging system 110 of FIGS. 1A and 1B) may be configured for supporting three-dimensional (3D) visualization and/or printing with three-dimensional (3D) model cuts based on anatomy. In this regard, as noted above, three-dimensional (3D) models of anatomical regions (e.g. organs, bones, regions of interest) are used more and more, such as for patient education, training and research. Three-dimensional (3D) models of anatomical regions may also be used in diagnosis, treatment planning and treatment of patients.

Accordingly, optimizing and enhancing 3D modeling of anatomical regions, particularly ones that provide more internal details, is desirable. Implementations in accordance with the present disclosure allow for such enhancement of 3D modeling, particularly by use of anatomical based cuts. In this regard, use of anatomical cuts allows for visualizing the inside of 3D models (for hollow models) and/or for including of interior models (corresponding to interior structures or features) within larger 3D models. Solutions in accordance with the present disclosure provide methods and systems for automatic generation of cut surfaces based on anatomy, to allow generating 3D models (for, e.g., 3D visualization and/or prints) in several parts such that the inside of objects may be more easily visible. In this regard, cut surfaces may comprise cut planes though non-plane based cuts may also be used. Using these solutions the split(s) between the different parts of the objects may be automatically generated based on the anatomical properties of each object.

Thus, arrangements comprising medical imaging systems may be configured to incorporate or support 3D visualization and/or printing with cuts based on anatomy—that is, for providing automatically cuts of 3D models based on anatomy, and for use of anatomical information during 3D model cut. In this regard, data for 3D visualization and/or prints may be based on and/or incorporates cuts based on the anatomy information (such as vessel centerline) and the location of inner 3D models. The cuts between the objects are not be planar and would rather depend on the anatomical features (e.g. vessel curvature).

In some implementations, automatic preliminary cuts may be proposed (by the system), and the user may then be able to manage the cuts—e.g., editing the cuts and/or choosing the local plane orientations. Use of 3D visualization and/or prints with cuts based on anatomy may offer many advantages over any existing solutions, such as simplification, reduction of 3D model generation time, and added value for 3D printed object visualization. In some implementations, at least some of the processing relating to 3D visualization and printing, including the generation of 3D models (or data corresponding thereto) based on the volume renderings in the medical imaging systems, may be offloaded from medical imaging systems—e.g., to another computer, configured for medical imaging visualization, and different from a computer used for the medical imaging acquisition.

The use of such three-dimensional (3D) visualization and/or 3D printing, with three-dimensional (3D) model based cuts based on anatomy, may have many applications. For example, 3D models with anatomical based cuts may be used for visualizing inner features and/or structures in 3D manner. In this regard, 3D models may be obtained from a merged 3D view and from multiple modalities (e.g. brain model from MRI and skull model from CT), and successive cuts may then be performed of the 3D models which are within other inner 3D models.

Another application may be for 3D modeling of blood vessels. In this regard, 3D visualization and/or prints of blood vessels may be particularly useful (e.g., for interventional surgery training and planning (vascular applications), etc.). In this context, 3D models may be based on the vessels inner walls with a constant external wall thickness depending on the 3D printer and material limitations. With 3D visualization and/or prints of hollow models, the inner wall is difficult to check and to visualize as it is within the 3D object. This may be addressed using automatic cuts, however, as use of automatic cut of the hollow vessel tree based on the vessel centerlines of each vessel branch would provide enhanced 3D models of the vessels.

Another application may be pulmonary based 3D modeling, such as of a pulmonary tree. In this regard, 3D visualization and/or prints of hollow pulmonary trees may be useful to assess pulmonary bronchi. Having cut hollow vessel allow visualizing inside the bronchi, which may be advantageous (e.g., in helping with diagnosis). Another application may be for spinal prints—e.g., with cuts of vertebra 3D models based on spine curve to assess the vertebral column.

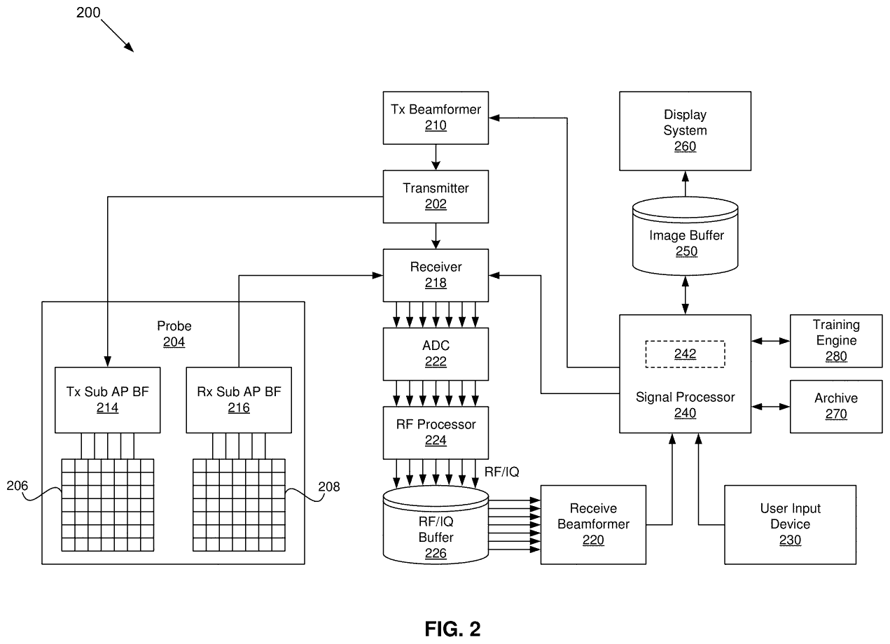

FIG. 2 is a block diagram illustrating an example ultrasound system that may be configured for supporting three-dimensional (3D) visualization and/or printing with three-dimensional (3D) model cuts based on anatomy. Shown in FIG. 2 is an ultrasound system 200.

The ultrasound system 200 may be configured for providing ultrasound imaging, and as such may comprise suitable circuitry, interfaces, logic, and/or code for performing and/or supporting ultrasound imaging related functions. The ultrasound system 200 may correspond to the medical imaging system 110 of FIG. 1.

The ultrasound system 200 comprises, for example, a transmitter 202, an ultrasound probe 204, a transmit beamformer 210, a receiver 218, a receive beamformer 220, a RF processor 224, a RF/IQ buffer 226, a user input module 230, a signal processor 240, an image buffer 250, a display system 260, an archive 270, and a training engine 280.

The transmitter 202 may comprise suitable circuitry, interfaces, logic, and/or code that may be operable to drive an ultrasound probe 204. The ultrasound probe 204 may comprise a two dimensional (2D) array of piezoelectric elements. The ultrasound probe 204 may comprise a group of transmit transducer elements 206 and a group of receive transducer elements 208, that normally constitute the same elements. In certain embodiment, the ultrasound probe 204 may be operable to acquire ultrasound image data covering at least a substantial portion of an anatomy, such as the heart, a blood vessel, or any suitable anatomical structure.

The transmit beamformer 210 may comprise suitable circuitry, interfaces, logic, and/or code that may be operable to control the transmitter 202 which, through a transmit sub-aperture beamformer 214, drives the group of transmit transducer elements 206 to emit ultrasonic transmit signals into a region of interest (e.g., human, animal, underground cavity, physical structure and the like). The transmitted ultrasonic signals may be back-scattered from structures in the object(s) of interest, like blood cells or tissue, to produce echoes. The echoes are received by the receive transducer elements 208.

The group of receive transducer elements 208 in the ultrasound probe 204 may be operable to convert the received echoes into analog signals, undergo sub-aperture beamforming by a receive sub-aperture beamformer 216 and are then communicated to a receiver 218. The receiver 218 may comprise suitable circuitry, interfaces, logic, and/or code that may be operable to receive the signals from the receive sub-aperture beamformer 216. The analog signals may be communicated to one or more of the plurality of A/D converters 222.

The plurality of A/D converters 222 may comprise suitable circuitry, interfaces, logic, and/or code that may be operable to convert the analog signals from the receiver 218 to corresponding digital signals. The plurality of A/D converters 222 are disposed between the receiver 218 and the RF processor 224. Notwithstanding, the disclosure is not limited in this regard. Accordingly, in some embodiments, the plurality of A/D converters 222 may be integrated within the receiver 218.

The RF processor 224 may comprise suitable circuitry, interfaces, logic, and/or code that may be operable to demodulate the digital signals output by the plurality of A/D converters 222. In accordance with an embodiment, the RF processor 224 may comprise a complex demodulator (not shown) that is operable to demodulate the digital signals to form I/Q data pairs that are representative of the corresponding echo signals. The RF or I/Q signal data may then be communicated to an RF/IQ buffer 226. The RF/IQ buffer 226 may comprise suitable circuitry, interfaces, logic, and/or code that may be operable to provide temporary storage of the RF or I/Q signal data, which is generated by the RF processor 224.

The receive beamformer 220 may comprise suitable circuitry, interfaces, logic, and/or code that may be operable to perform digital beamforming processing to, for example, sum the delayed channel signals received from RF processor 224 via the RF/IQ buffer 226 and output a beam summed signal. The resulting processed information may be the beam summed signal that is output from the receive beamformer 220 and communicated to the signal processor 240. In accordance with some embodiments, the receiver 218, the plurality of A/D converters 222, the RF processor 224, and the beamformer 220 may be integrated into a single beamformer, which may be digital. In various embodiments, the ultrasound system 200 comprises a plurality of receive beamformers 220.

The user input device 230 may be utilized to input patient data, scan parameters, settings, select protocols and/or templates, interact with an artificial intelligence segmentation processor to select tracking targets, and the like. In an example embodiment, the user input device 230 may be operable to configure, manage and/or control operation of one or more components and/or modules in the ultrasound system 200. In this regard, the user input device 230 may be operable to configure, manage and/or control operation of the transmitter 202, the ultrasound probe 204, the transmit beamformer 210, the receiver 218, the receive beamformer 220, the RF processor 224, the RF/IQ buffer 226, the user input device 230, the signal processor 240, the image buffer 250, the display system 260, and/or the archive 270.

For example, the user input device 230 may include button(s), rotary encoder(s), a touchscreen, motion tracking, voice recognition, a mouse device, keyboard, camera and/or any other device capable of receiving user directive(s). In certain embodiments, one or more of the user input devices 230 may be integrated into other components, such as the display system 260 or the ultrasound probe 204, for example. As an example, user input device 230 may include a touchscreen display. As another example, user input device 230 may include an accelerometer, gyroscope, and/or magnetometer attached to and/or integrated with the probe 204 to provide gesture motion recognition of the probe 204, such as to identify one or more probe compressions against a patient body, a pre-defined probe movement or tilt operation, or the like. Additionally and/or alternatively, the user input device 230 may include image analysis processing to identify probe gestures by analyzing acquired image data.

The signal processor 240 may comprise suitable circuitry, interfaces, logic, and/or code that may be operable to process ultrasound scan data (i.e., summed IQ signal) for generating ultrasound images for presentation on a display system 260. The signal processor 240 is operable to perform one or more processing operations according to a plurality of selectable ultrasound modalities on the acquired ultrasound scan data. In an example embodiment, the signal processor 240 may be operable to perform display processing and/or control processing, among other things. Acquired ultrasound scan data may be processed in real-time during a scanning session as the echo signals are received. Additionally or alternatively, the ultrasound scan data may be stored temporarily in the RF/IQ buffer 226 during a scanning session and processed in less than real-time in a live or off-line operation. In various embodiments, the processed image data can be presented at the display system 260 and/or may be stored at the archive 270. The archive 270 may be a local archive, a Picture Archiving and Communication System (PACS), or any suitable device for storing images and related information.

The signal processor 240 may be one or more central processing units, microprocessors, microcontrollers, and/or the like. The signal processor 240 may be an integrated component, or may be distributed across various locations, for example. The signal processor 240 may be configured for receiving input information from the user input device 230 and/or the archive 270, generating an output displayable by the display system 260, and manipulating the output in response to input information from the user input device 230, among other things. The signal processor 240 may be capable of executing any of the method(s) and/or set(s) of instructions discussed herein in accordance with the various embodiments, for example.

The ultrasound system 200 may be operable to continuously acquire ultrasound scan data at a frame rate that is suitable for the imaging situation in question. Typical frame rates range from 20-220 but may be lower or higher. The acquired ultrasound scan data may be displayed on the display system 260 at a display-rate that can be the same as the frame rate, or slower or faster. The image buffer 250 is included for storing processed frames of acquired ultrasound scan data that are not scheduled to be displayed immediately. Preferably, the image buffer 250 is of sufficient capacity to store at least several minutes' worth of frames of ultrasound scan data. The frames of ultrasound scan data are stored in a manner to facilitate retrieval thereof according to its order or time of acquisition. The image buffer 250 may be embodied as any known data storage medium.

In an example embodiment, the signal processor 240 may comprise a three-dimensional (3D) modeling module 242, which comprises suitable circuitry, interfaces, logic, and/or code that may be configured to perform and/or support various functions or operations relating to, or in support of three-dimensional (3D) visualization and/or printing with three-dimensional (3D) model cuts based on anatomy, as described in more detail below.

In some implementations, the signal processor 240 (and/or components thereof, such as the 3D modeling module 242) may be configured to implement and/or use deep learning techniques and/or algorithms, such as using deep neural networks (e.g., a convolutional neural network), and/or may utilize any suitable form of artificial intelligence image analysis techniques or machine learning processing functionality, which may be configured to analyze acquired ultrasound images, such as to identify, segment, label, and track structures meeting particular criteria and/or having particular characteristics.

In some implementations, the signal processor 240 (and/or components thereof, such as the 3D modeling module 242) may be provided as a deep neural network, which may be made up of, for example, an input layer, an output layer, and one or more hidden layers in between the input and output layers. Each of the layers may be made up of a plurality of processing nodes that may be referred to as neurons. For example, the deep neural network may include an input layer having a neuron for each pixel or a group of pixels from a scan plane of an anatomical structure. The output layer may have a neuron corresponding to a plurality of pre-defined structures or types of structures. Each neuron of each layer may perform a processing function and pass the processed ultrasound image information to one of a plurality of neurons of a downstream layer for further processing. As an example, neurons of a first layer may learn to recognize edges of structure in the ultrasound image data. The neurons of a second layer may learn to recognize shapes based on the detected edges from the first layer. The neurons of a third layer may learn positions of the recognized shapes relative to landmarks in the ultrasound image data. Thus, the processing performed by the deep neural network (e.g., convolutional neural network) may allow for identifying biological and/or artificial structures in ultrasound image data with a high degree of probability.

In certain implementations, the signal processor 240 (and/or components thereof, such as the 3D modeling module 242) may be configured to perform or otherwise control at least some of the functions performed thereby based on a user instruction via the user input device 230. As an example, a user may provide a voice command, probe gesture, button depression, or the like to issue a particular instruction, such as to request performing three-dimensional (3D) visualization and/or printing, particularly with 3D model cuts based on anatomy, and/or to provide or otherwise specify various parameters or settings pertinent to performing such 3D visualization and/or printing.

The training engine 280 may comprise suitable circuitry, interfaces, logic, and/or code that may be operable to train the neurons of the deep neural network(s) of the signal processor 240 (and/or components thereof, such as the 3D modeling module 242). For example, the signal processor 240 may be trained to identify particular structures or types of structures provided in an ultrasound scan plane, with the training engine 280 training the deep neural network(s) thereof to perform some of the required functions, such as using databases(s) of classified ultrasound images of various structures.

As an example, the training engine 280 may be configured to utilize ultrasound images of particular structures to train the signal processor 240 (and/or components thereof, such as the 3D modeling module 242) with respect to the characteristics of the particular structure(s), such as the appearance of structure edges, the appearance of structure shapes based on the edges, the positions of the shapes relative to landmarks in the ultrasound image data, and the like. In various embodiments, the databases of training images may be stored in the archive 270 or any suitable data storage medium. In certain embodiments, the training engine 280 and/or training image databases may be external system(s) communicatively coupled via a wired or wireless connection to the ultrasound system 200.

In operation, the ultrasound system 200 may be used in generating ultrasonic images, including two-dimensional (2D), three-dimensional (3D), and/or four-dimensional (4D) images. In this regard, the ultrasound system 200 may be operable to continuously acquire ultrasound scan data at a particular frame rate, which may be suitable for the imaging situation in question. For example, frame rates may range from 20-70 but may be lower or higher. The acquired ultrasound scan data may be displayed on the display system 260 at a display-rate that can be the same as the frame rate, or slower or faster. An image buffer 250 is included for storing processed frames of acquired ultrasound scan data not scheduled to be displayed immediately. Preferably, the image buffer 250 is of sufficient capacity to store at least several seconds' worth of frames of ultrasound scan data. The frames of ultrasound scan data are stored in a manner to facilitate retrieval thereof according to its order or time of acquisition. The image buffer 250 may be embodied as any known data storage medium.

In some instances, the ultrasound system 200 may be configured to support grayscale and color based operations. For example, the signal processor 240 may be operable to perform grayscale B-mode processing and/or color processing. The grayscale B-mode processing may comprise processing B-mode RF signal data or IQ data pairs. For example, the grayscale B-mode processing may enable forming an envelope of the beam-summed receive signal by computing the quantity (I²+Q²)^{1/2}. The envelope can undergo additional B-mode processing, such as logarithmic compression to form the display data. The display data may be converted to X-Y format for video display. The scan-converted frames can be mapped to grayscale for display. The B-mode frames that are provided to the image buffer 250 and/or the display system 260. The color processing may comprise processing color based RF signal data or IQ data pairs to form frames to overlay on B-mode frames that are provided to the image buffer 250 and/or the display system 260. The grayscale and/or color processing may be adaptively adjusted based on user input—e.g., a selection from the user input device 230, for example, for enhance of grayscale and/or color of particular area.

In some instances, ultrasound imaging may include generation and/or display of volumetric ultrasound images—that is where objects (e.g., organs, tissues, etc.) are displayed three-dimensional (3D). In this regard, with 3D (and similarly 4D) imaging, volumetric ultrasound datasets may be acquired, comprising voxels that correspond to the imaged objects. This may be done, e.g., by transmitting the sound waves at different angles rather than simply transmitting them in one direction (e.g., straight down), and then capture their reflections back. The returning echoes (of transmissions at different angles) are then captured, and processed (e.g., via the signal processor 240) to generate the corresponding volumetric datasets, which may in turn be used in creating and/or displaying volume (e.g. 3D) images, such as via the display 250. This may entail use of particular handling techniques to provide the desired 3D perception.

For example, volume rendering techniques may be used in displaying projections (e.g., 2D projections) of the volumetric (e.g., 3D) datasets. In this regard, rendering a 2D projection of a 3D dataset may comprise setting or defining a perception angle in space relative to the object(s) being displayed, and then defining or computing necessary information (e.g., opacity and color) for every voxel in the dataset. This may be done, for example, using suitable transfer functions for defining RGBA (red, green, blue, and alpha) value for every voxel.

In accordance with the present disclosure, medical imaging system (e.g., the ultrasound system 200) may be configured to support three-dimensional (3D) visualization and/or printing with three-dimensional (3D) model cuts based on anatomy. In this regard, three-dimensional (3D) visualization and/or prints of anatomical regions (e.g. organs, bones, regions of interest) are used more and more, such as, e.g., for patient education, training and research, diagnosis, treatment planning and treatment of patients. Having anatomical cuts of 3D visualized and/or printed objects enhances 3D prints as it allows, e.g., for visualizing the inside of 3D models (for hollow models), and for visualizing models contained within larger 3D models. In various implementations such anatomical based cuts may be made during imaging operations to enable generating 3D visualization and/or prints (or corresponding data) incorporating 3D anatomical cuts, such that the interior and/or details within imaged objects are accurately shown in the 3D visualization and/or prints. Example of such 3D visualization and/or prints are shown and described in more detail below.

The 3D cuts may be generated automatically during imaging operations, with or without user input. In this regard, a workflow for generation of cut surface based on anatomy to generate 3D models in several parts for 3D visualization and/or printing may be used, with the systems being configured to implement and use such workflow. One of the key differentiators for such workflows is the straightforward 3D model creation workflow from the medical imaging diagnostic software to the 3D visualization and/or prints. In this regard, cuts between the different parts of imaged object(s) may be generated (automatically or manually) based on the anatomical properties of the object.

For example, in the system 200, during imaging operations, once an object is displayed in three-dimensional (3D) manner, as described above, 3D prints of the displayed objects may be created (e.g., based on user input/selection), and additionally 3D cuts based on anatomy may be used and incorporated into the 3D prints. In this regard, cuts in the displayed 3D views of the objects may be generated based on the anatomical properties of displayed objects. The anatomical properties may be determined and/or assessed in the system, such as based on predefined data and/or information obtained during imaging operations—e.g., determined via the signal processor 240/3D modeling module 242 using learning and training functions as described above. The cuts may be set and/or positions manually (or semi-assisted) by the user, with cut surfaces (e.g., cut planes) positioning in 3D views using user input device 230. Alternatively, at least some of the cuts may be automatically set and/or positioned, such as for specific contexts (e.g., vessel and pulmonary tree cut—such as, curvilinear cuts based on tree centerlines).

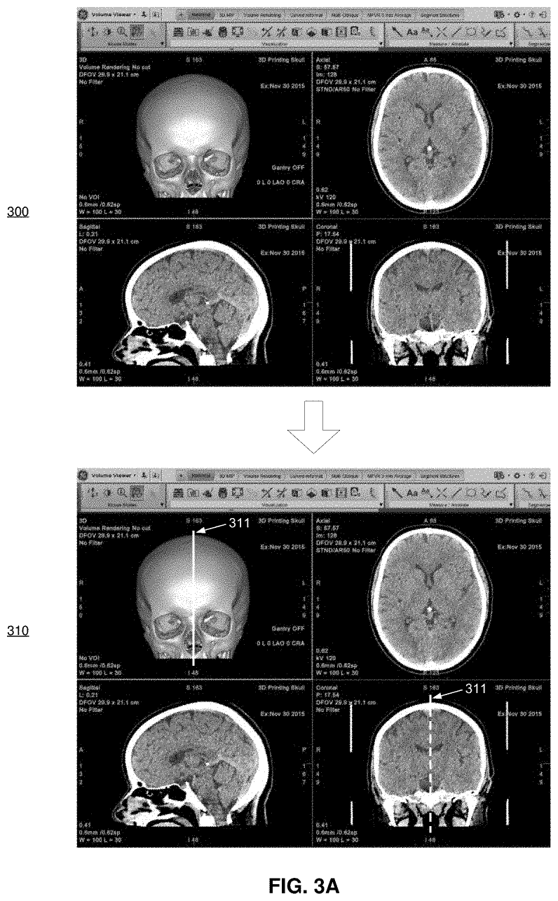

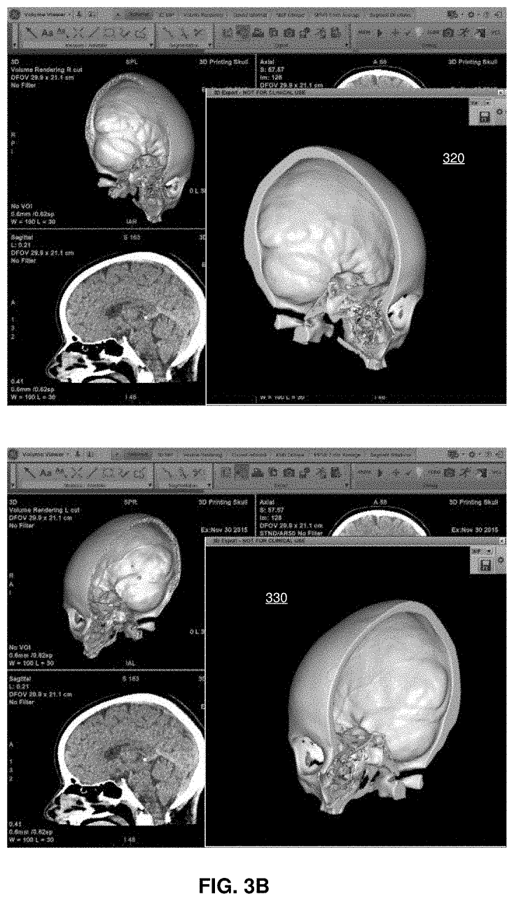

FIGS. 3A-3B illustrate an example workflow for manually controlled process for generating three-dimensional (3D) visualization and/or printing with three-dimensional (3D) model cuts based on anatomy during medical imaging. Shown in FIGS. 3A-3B is a sequence of screenshots corresponding to process for generating 3D prints (or 3D printing data) for one object with a single cut based on anatomy.

For example, during medical imaging (e.g., CT scan) operation, diagnostic medical imaging software with volume rendering 3D may be used in generating and displaying object(s) (patent's head) to a user (e.g., CT technician), as shown in screenshot 300. A cut plane 311 may then be applied, as shown in screenshot 310. In this regard, the cut may be manually positioned (by the user) in the 3D rendered image(s) of the objects. The positioning of the cut 311 may allow for creating and exporting simultaneously two cut 3D model parts (320 and 330, as shown in FIG. 3B) for 3D printing. In this regard, the two model parts 320 and 330 may include data for facilitating 3D visualization and/or prints showing the interior of the objects (e.g., cross section in the skull, brain, etc.) from different perspectives based on the cut 311. Printing data corresponding to the interior of the object(s) may be set or adjusted based on information obtained during imaging operations (as related to the particular person being examined), as well as (optionally) preprogrammed information relating to similar objects. A similar workflow may be used for multi objects by using 3D view with multi objects to apply same cut to multi objects simultaneously.

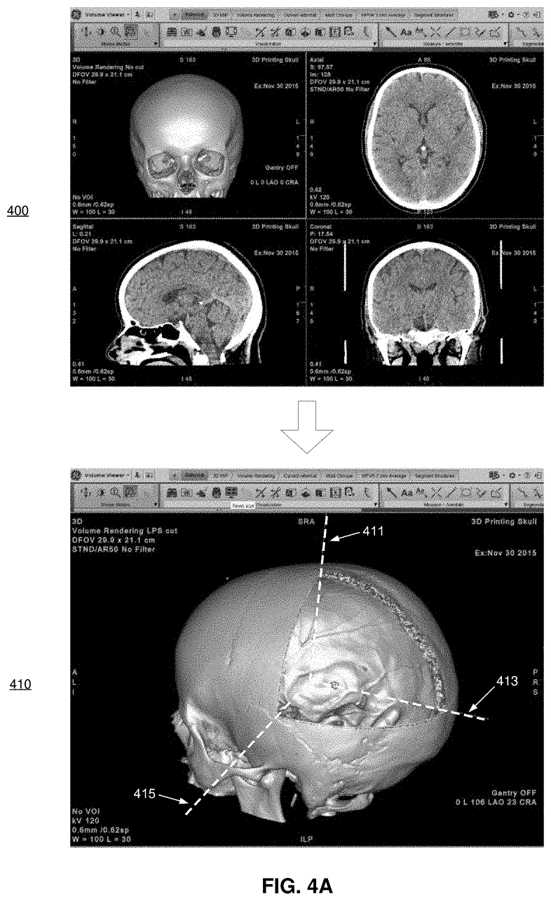

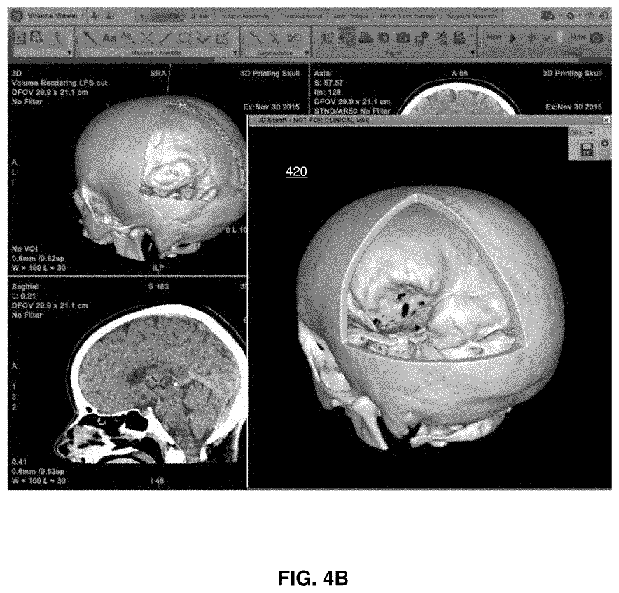

FIGS. 4A-4B illustrate an example workflow for manually controlled process for generating three-dimensional (3D) model cuts, using multiple cut planes, based on anatomy for three-dimensional (3D) visualization and/or printing during medical imaging. Shown in FIGS. 4A-4B is a sequence of screenshots corresponding to a process for generating 3D prints (or 3D printing data) for one object using multiple cuts based on anatomy.

In this regard, FIGS. 4A-4B illustrated in example of a more advanced cut configuration using the same use scenario shown in FIGS. 3A-3B. For example, the screenshot 400 shown in FIG. 4A shows the same image(s) illustrated in FIG. 3A, corresponding to 3D image(s) of an object (patient's head) as generated during example medical imaging operations, using diagnostic medical imaging software with volume rendering 3D view. However, as shown in screenshot 410 of FIG. 4A, rather than use a single cut, multiple cuts (411, 413, and 415) are used. In this regard, the cuts 411, 413, and 415 may be manually positioned (by the user/imaging technician) in the 3D rendered image(s) of the objects. As shown in FIG. 4B, the multiple cuts 411, 413, and 415 are then used in generating data for 3D visualization and/or printing data, for exporting simultaneously two cut 3D model parts (e.g., a skull cut part and a remaining skull part, allowing for visualization of the interior of the head and/or cross-section of the skull).

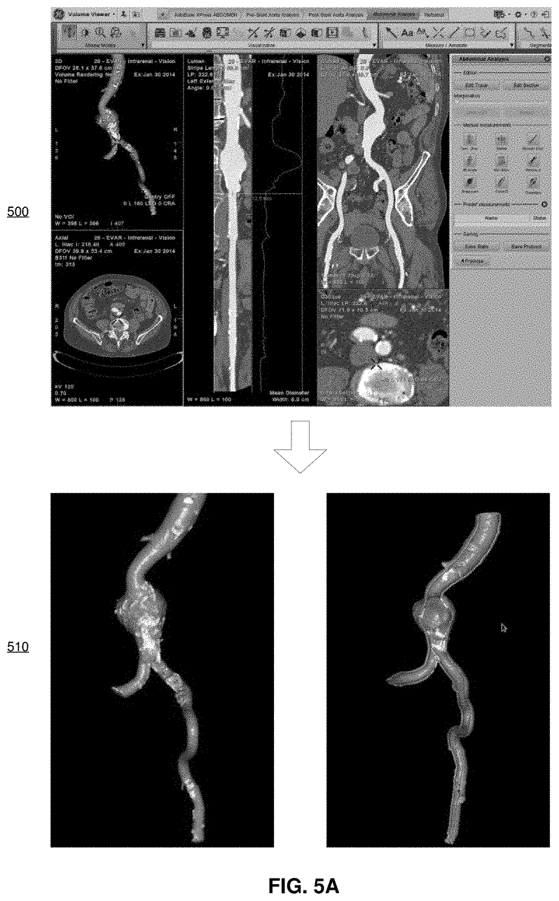

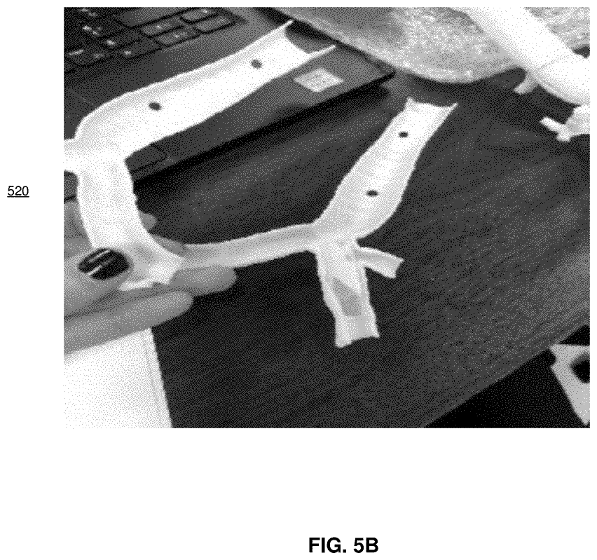

FIGS. 5A-5B illustrate an example workflow for automatically controlled process for generating three-dimensional (3D) model cuts, based on anatomy for three-dimensional (3D) visualization and/or printing during medical imaging. Shown in FIGS. 5A-5B is a sequence of screenshots corresponding to a process for generating 3D visualization and/or prints for an object (blood vessel) using automatic cuts based on anatomy.

In this regard, the process illustrated in FIGS. 5A-5B is based on an advanced workflow for 3D model vessel cut. For example, during medical imaging operation, diagnostic medical imaging software with volume rendering 3D may be used in generating and displaying image(s) of a vessel, as shown in screenshot 500. Automatic curvilinear cut(s) based on pre-computed vessel tree centerline may then be applied, as shown in screenshot 510. In some instances, the user (e.g., imaging technician) may adjust cut directions in the 3D images. Once the cuts are finalized, cut 3D model parts may be exported simultaneously for 3D visualization and/or printing (e.g., being used to generate 3D prints as shown in screenshot 520 of FIG. 5B). An advanced automatic process such as the one described with respect to FIGS. 5A-5B may be particularly useful with hollow objects, such as vessel model (e.g. to assess stenosis or to prepare stent placement).

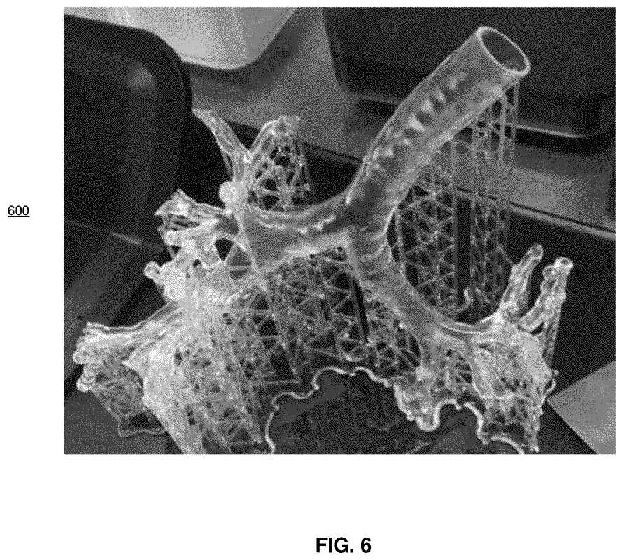

FIG. 6 illustrates a three-dimensional (3D) model pulmonary cut generated using advanced workflow for generating three-dimensional (3D) model cuts, based on anatomy for three-dimensional (3D) visualization and/or printing during medical imaging. Shown in FIG. 6 is a three-dimensional (3D) print 600 generated using 3D printing with cuts based on anatomy. For example, the 3D print 600 may be generated using an advanced workflow for 3D model pulmonary cut, using a similar process as the one described with respect to FIGS. 5A-5B. The 3D printing of hollow pulmonary trees may be used to allow assessing pulmonary bronchi. In this regard, cut of hollow bronchi allows visualizing inside the bronchi to help the diagnosis.

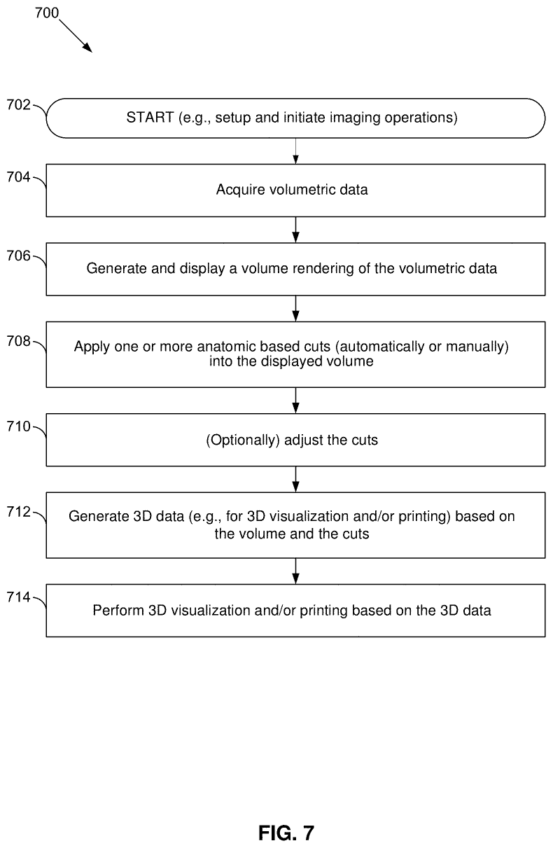

FIG. 7 illustrates a flowchart of an example steps that may be performed for three-dimensional (3D) visualization and/or printing with three-dimensional (3D) model cuts based on anatomy. Shown in FIG. 7 is flow chart 700, comprising a plurality of example steps (represented as blocks 702-714), which may be performed in a suitable system (e.g., medical imaging system 110 of FIGS. 1A and 1B) for generating three-dimensional (3D) visualization and/or prints, with three-dimensional (3D) model cuts based on anatomy, based on medical imaging.

In start step 702, the system may be setup, and operations may initiate.

In step 704, volumetric data is acquired—e.g., using the scanner 112 of the medical imaging system 110. The volumetric data may be, e.g., ultrasound image data acquired with an ultrasound probe, CT image data acquired with a CT scanner, MRI image data acquired with an MRI scanner, and/or any suitable medical volumetric imaging data acquired from a medical imaging device scanner.

In step 706, based on the acquired volumetric data, a volume rendering may be generated and displayed. For example, the medical imaging system 110 or computer system 160 may generate a volume rendering based on the volumetric data acquired at step 704. The volume rendering may comprise volumetric data image(s), which may be presented at a display screen (e.g., the display screen 116 of the medical imaging system 110 and/or at any suitable display system).

In step 708, one or more cuts based on anatomy may be applied (automatically or manually) into the displayed volume. In this regard, as described above, the cuts may be positioned based on anatomical features associated with object(s) in the displayed volume.

In optional step 710, the cuts may be adjusted. In this regard, in some instances the user (e.g., imaging technician) may be able to adjust positioning, direction, or location of the cuts.

In step 712, three-dimensional (3D) model, configured for 3D visualization and/or printing, may be generated based on the volume and the cuts. For example, data for the 3D model(s) may be generated based on the volumetric data and the cuts—e.g., to enable showing the inside and/or details of object(s) in the displayed volume during 3D visualization and/or printing.

In step 714, three-dimensional (3D) visualization and/or printing may be performed based on the 3D data generated in step 712.

An example method for three-dimensional printing, in accordance with the present disclosure, comprises generating, by a processor, a volume rendering from volumetric imaging data; displaying, via a display device, the volume rendering; and based on one or more cut surfaces corresponding to an object in the volume rendering, generating three-dimensional (3D) data for a corresponding three-dimensional (3D) model. The one or more cut surfaces are set or adjusted based on anatomical features associated with the object. The three-dimensional (3D) data comprises one or both of: three-dimensional (3D) data corresponding to or representing at least one internal space within the object; and three-dimensional (3D) data corresponding to or representing at least one internal object or structure within the object. The three-dimensional (3D) data is configured to enable one or both of: three-dimensional (3D) visualization of the object, including one or both of the at least one internal space and the at least one internal object or structure; and producing, via a three-dimensional (3D) printer, a physical volume representation of the object including one or both of the at least one internal space and the at least one internal object or structure.

In an example embodiment, the method further comprises generating the three-dimensional (3D) data based on the volumetric data.

In an example embodiment, the method further comprises automatically generating at least one of the one or more cut surfaces based on pre-defined anatomical features associated with the object.

In an example embodiment, the method further comprises generating at least one of the one or more cut surfaces based on user input.

In an example embodiment, the method further comprises adjusting at least one cut surface of the one or more cut surfaces based on user input, the adjusting relating to at least positioning of the at least one cut surface.

The method of claim 1, comprising generating the volumetric imaging data based on a particular medical imaging technique. The particular imaging technique may comprise ultrasound imaging, computed tomography (CT) scan imaging, magnetic resonance imaging (MRI) imaging, cone-beam computed tomography (CBCT), and any other form of tomography, microscopy, or in general any imaging technique that may be provide or support three-dimensional (3D) imaging.

An example non-transitory computer readable medium, in accordance with the present disclosure, may have stored thereon it a computer program having at least one code section, the at least one code section being executable by a machine comprising at least one processor, for causing the machine to perform one or more steps comprising: generating a volume rendering from volumetric imaging data; displaying, via a display device, the volume rendering; and based on one or more cut surfaces corresponding to an object in the volume rendering, generating three-dimensional (3D) data for a corresponding three-dimensional (3D) model. The one or more cut surfaces are set or adjusted based on anatomical features associated with the object. The three-dimensional (3D) data comprises one or both of: three-dimensional (3D) data corresponding to or representing at least one internal space within the object; and three-dimensional (3D) data corresponding to or representing at least one internal object or structure within the object. The three-dimensional (3D) data is configured to enable one or both of: three-dimensional (3D) visualization of the object, including one or both of the at least one internal space and the at least one internal object or structure; and producing, via a three-dimensional (3D) printer, a physical volume representation of the object including one or both of the at least one internal space and the at least one internal object or structure.

In an example embodiment, the one or more steps further comprise generating the three-dimensional (3D) data based on the volumetric data.

In an example embodiment, the one or more steps further comprise automatically generating at least one of the one or more cut surfaces based on pre-defined anatomical features associated with the object.

In an example embodiment, the one or more steps further comprise generating at least one of the one or more cut surfaces based on user input.

In an example embodiment, the one or more steps further comprise adjusting at least one cut surface of the one or more cut surfaces based on user input, the adjusting relating to at least positioning of the at least one cut surface.

In an example embodiment, the one or more steps further comprise generating the volumetric imaging data based on a particular medical imaging technique. The particular imaging technique may comprise ultrasound imaging, computed tomography (CT) scan imaging, magnetic resonance imaging (MRI) imaging, cone-beam computed tomography (CBCT), and any other form of tomography, microscopy, or in general any imaging technique that may be provide or support three-dimensional (3D) imaging.

An example system for three-dimensional printing, in accordance with the present disclosure, comprises an electronic device comprising at least one processor, wherein the electronic device is configured to generate a volume rendering from volumetric imaging data; display, via a display device, the volume rendering; and based on one or more cut surfaces corresponding to an object in the volume rendering, generate three-dimensional (3D) data for a corresponding three-dimensional (3D) model. The one or more cut surfaces are set or adjusted based on anatomical features associated with the object. The three-dimensional (3D) data comprises one or both of: three-dimensional (3D) data corresponding to or representing at least one internal space within the object; and three-dimensional (3D) data corresponding to or representing at least one internal object or structure within the object. The three-dimensional (3D) data is configured to enable one or both of: three-dimensional (3D) visualization of the object, including one or both of the at least one internal space and the at least one internal object or structure; and producing, via a three-dimensional (3D) printer, a physical volume representation of the object including one or both of the at least one internal space and the at least one internal object or structure.

In an example embodiment, the electronic device is further configured to generate the three-dimensional (3D) data based on the volumetric data.

In an example embodiment, the electronic device is further configured to automatically generate at least one of the one or more cut surfaces based on pre-defined anatomical features associated with the object.

In an example embodiment, the electronic device is further configured to generate at least one of the one or more cut surfaces based on user input.

In an example embodiment, the electronic device is further configured to adjust at least one cut surface of the one or more cut surfaces based on user input, the adjusting relating to at least positioning of the at least one cut surface.

In an example embodiment, the electronic device is further configured to generate the volumetric imaging data based on a particular medical imaging technique. The particular imaging technique may comprise ultrasound imaging, computed tomography (CT) scan imaging, magnetic resonance imaging (MRI) imaging, cone-beam computed tomography (CBCT), and any other form of tomography, microscopy, or in general any imaging technique that may be provide or support three-dimensional (3D) imaging.

As utilized herein the terms “circuits” and “circuitry” refer to physical electronic components (e.g., hardware) and any software and/or firmware (“code”) which may configure the hardware, be executed by the hardware, and or otherwise be associated with the hardware. As used herein, for example, a particular processor and memory may comprise a first “circuit” when executing a first one or more lines of code and may comprise a second “circuit” when executing a second one or more lines of code. As utilized herein, “and/or” means any one or more of the items in the list joined by “and/or”. As an example, “x and/or y” means any element of the three-element set {(x), (y), (x, y)}. In other words, “x and/or y” means “one or both of x and y.” As another example, “x, y, and/or z” means any element of the seven-element set {(x), (y), (z), (x, y), (x, z), (y, z), (x, y, z)}. In other words, “x, y and/or z” means “one or more of x, y, and z.” As utilized herein, the terms “block” and “module” refer to functions than can be performed by one or more circuits. As utilized herein, the term “exemplary” means serving as a non-limiting example, instance, or illustration. As utilized herein, the terms “for example” and “e.g.,” set off lists of one or more non-limiting examples, instances, or illustrations. As utilized herein, circuitry is “operable” to perform a function whenever the circuitry comprises the necessary hardware (and code, if any is necessary) to perform the function, regardless of whether performance of the function is disabled or not enabled (e.g., by some user-configurable setting, a factory trim, etc.).

Other embodiments of the invention may provide a non-transitory computer readable medium and/or storage medium, and/or a non-transitory machine readable medium and/or storage medium, having stored thereon, a machine code and/or a computer program having at least one code section executable by a machine and/or a computer, thereby causing the machine and/or computer to perform the processes as described herein.

Accordingly, the present disclosure may be realized in hardware, software, or a combination of hardware and software. The present invention may be realized in a centralized fashion in at least one computing system, or in a distributed fashion where different elements are spread across several interconnected computing systems. Any kind of computing system or other apparatus adapted for carrying out the methods described herein is suited. A typical combination of hardware and software may be a general-purpose computing system with a program or other code that, when being loaded and executed, controls the computing system such that it carries out the methods described herein. Another typical implementation may comprise an application specific integrated circuit or chip.

Various embodiments in accordance with the present disclosure may also be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

While the present invention has been described with reference to certain embodiments, it will be understood by those skilled in the art that various changes may be made and equivalents may be substituted without departing from the scope of the present invention. In addition, many modifications may be made to adapt a particular situation or material to the teachings of the present invention without departing from its scope. Therefore, it is intended that the present invention not be limited to the particular embodiment disclosed, but that the present invention will include all embodiments falling within the scope of the appended claims.

What is claimed is:

1. A method comprising:
generating, by a processor, a volume rendering from volumetric imaging data;
displaying, via a display device, the volume rendering; and
based on one or more cut surfaces corresponding to an object in the volume rendering, generating three-dimensional (3D) data for a corresponding three-dimensional (3D) model, wherein:
the one or more cut surfaces are set or adjusted based on anatomical features associated with the object;
the three-dimensional (3D) data comprises one or both of:
three-dimensional (3D) data corresponding to or representing at least one internal space within the object; and
three-dimensional (3D) data corresponding to or representing at least one internal object or structure within the object; and
the three-dimensional (3D) data is configured to enable one or both of:
three-dimensional (3D) visualization of the object, including one or both of the at least one internal space and the at least one internal object or structure; and
producing, via a three-dimensional (3D) printer, a physical volume representation of the object including one or both of the at least one internal space and the at least one internal object or structure.

2. The method of claim 1, comprising generating the three-dimensional (3D) data based on the volumetric data.

3. The method of claim 1, comprising automatically generating at least one of the one or more cut surfaces based on pre-defined anatomical features associated with the object.

4. The method of claim 1, comprising generating at least one of the one or more cut surfaces based on user input.

5. The method of claim 1, comprising adjusting at least one cut surface of the one or more cut surfaces based on user input, the adjusting relating to at least positioning of the at least one cut surface.

6. The method of claim 1, comprising generating the volumetric imaging data based on a particular medical imaging technique.

7. The method of claim 6, wherein the particular imaging technique comprises at least one of ultrasound imaging, computed tomography (CT) scan imaging, and Magnetic resonance imaging (MRI) imaging.

8. A non-transitory computer readable medium having stored thereon, a computer program having at least one code section, the at least one code section being executable by a machine comprising at least one processor, for causing the machine to perform one or more steps comprising:
generating a volume rendering from volumetric imaging data;
displaying, via a display device, the volume rendering; and
based on one or more cut surfaces corresponding to an object in the volume rendering, generating three-dimensional (3D) data for a corresponding three-dimensional (3D) model, wherein:
the one or more cut surfaces are set or adjusted based on anatomical features associated with the object;
the three-dimensional (3D) data comprises one or both of:
three-dimensional (3D) data corresponding to or representing at least one internal space within the object; and
three-dimensional (3D) data corresponding to or representing at least one internal object or structure within the object; and
the three-dimensional (3D) data is configured to enable one or both of:
three-dimensional (3D) visualization of the object, including one or both of the at least one internal space and the at least one internal object or structure; and
producing, via a three-dimensional (3D) printer, a physical volume representation of the object including one or both of the at least one internal space and the at least one internal object or structure.

9. The non-transitory computer readable medium of claim 8, wherein the one or more steps comprise generating the three-dimensional (3D) data based on the volumetric data.

10. The non-transitory computer readable medium of claim 8, wherein the one or more steps comprise automatically generating at least one of the one or more cut surfaces based on pre-defined anatomical features associated with the object.

11. The non-transitory computer readable medium of claim 8, wherein the one or more steps comprise generating at least one of the one or more cut surfaces based on user input.

12. The non-transitory computer readable medium of claim 8, wherein the one or more steps comprise adjusting at least one cut surface of the one or more cut surfaces based on user input, the adjusting relating to at least positioning of the at least one cut surface.

13. The non-transitory computer readable medium of claim 8, wherein the one or more steps comprise generating the volumetric imaging data based on a particular medical imaging technique.

14. The non-transitory computer readable medium of claim 8, wherein the one or more steps comprise generating based on the three-dimensional (3D) data, corresponding three-dimensional (3D) printing data configured to enable producing, via a three-dimensional (3D) printer, a physical volume representation of the object including one or both of the at least one internal space and the at least one internal object or structure.

15. A system comprising:
an electronic device comprising at least one processor, wherein the electronic device is configured to
generate a volume rendering from volumetric imaging data;
display, via a display device, the volume rendering; and
based on one or more cut surfaces corresponding to an object in the volume rendering, generate three-dimensional (3D) data for a corresponding three-dimensional (3D) model, wherein:
the one or more cut surfaces are set or adjusted based on anatomical features associated with the object;
the three-dimensional (3D) data comprises one or both of:
three-dimensional (3D) data corresponding to or representing at least one internal space within the object; and
three-dimensional (3D) data corresponding to or representing at least one internal object or structure within the object; and
the three-dimensional (3D) data is configured to enable one or both of:
three-dimensional (3D) visualization of the object, including one or both of the at least one internal space and the at least one internal object or structure; and
producing, via a three-dimensional (3D) printer, a physical volume representation of the object including one or both of the at least one internal space and the at least one internal object or structure.

16. The system of claim 15, wherein the electronic device is configured to generate the three-dimensional (3D) data based on the volumetric data.

17. The system of claim 15, wherein the electronic device is configured to automatically generate at least one of the one or more cut surfaces based on pre-defined anatomical features associated with the object.

18. The system of claim 15, wherein the electronic device is configured to generate at least one of the one or more cut surfaces based on user input.

19. The system of claim 15, wherein the electronic device is configured to adjust at least one cut surface of the one or more cut surfaces based on user input, the adjusting relating to at least positioning of the at least one cut surface.

20. The system of claim 15, wherein the electronic device is configured to generate the volumetric imaging data based on a particular medical imaging technique, wherein the particular imaging technique comprises at least one of ultrasound imaging, computed tomography (CT) scan imaging, and magnetic resonance imaging (MRI) imaging.
